(19) United States
(12) Patent Application Publication
(10) Pub. No.: US 2023/0418582 A1
(43) Pub. Date: Dec. 28, 2023

(54) Information Technology Management System

(71) Applicant: Bank of America Corporation, Charlotte, NC (US)

(72) Inventors: Sathis Nagarajan, Tamil Nadu (IN); Satpal Singh Dua, Telangana (IN); Parveen Khan, Tamil Nadu (IN)

(21) Appl. No.: 17/847,297

(22) Filed: Jun. 23, 2022

(51) Int. Cl. G06F 8/61; G06F 8/65

(52) U.S. Cl. CPC G06F 8/61; G06F 8/65

(57) ABSTRACT

A transformation management computing system automatically extracts data from a plurality of the different computing systems and corresponding to a release of a software installation package. The transformation management computing system automatically consolidates and transforms the data to accommodate reporting needs and installation requirements. The transformation management computing system determine a current state of the servers and the operating systems, and applications, to determine which servers require a pending update/patch. The transformation management computing system then identify optimal times for deploying the update/patch to each of the servers and triggering the installation.

### BACKGROUND

Aspects of the disclosure relate to computer hardware and software. In particular, one or more aspects of the disclosure generally relate to computer hardware and software for deploying and managing of software updates and/or patches to networked servers within a computer network.

In many large enterprises, computing devices (e.g., workstations, servers and the like) or other networked computing devices are distributed globally across diverse computing network infrastructure. Often, various networked computing devices implement many different operating systems and facilitate execution of different software packages, applications, tools and the like. In some cases, a single server may host many different software packages, applications or the like.

To manage such a diverse and complex computing infrastructure, enterprises may typically employ support teams whose job is it to keep the systems running and insure that risk to the systems are minimized. Frequently operating system (OS) and/or software manufacturers will release updates, often in the form of patches, service packs, or the like. These updates are designed to minimize vulnerabilities and risks to their respective OS and/or software application. In this regard, many of the system updates and/or patches are deemed to be critical in addressing security fixes, so that these updates and/or patches are prioritized for deployment throughout the enterprise computing network in a timely fashion.

However, due to the many different computing environments, business unit computing needs and processes, enterprise organizations may find timely deployment of the updates/patches is highly problematic. Because data associated with servers, applications, business unit operation, and/or other data relevant to deploying the updates is spread across many different data sources; each of which must be constantly monitored to assess risk, vulnerabilities and the like. While many of these different data sources are capable of generating log files and creating reports that indicate the risk, current enterprise environment support teams members are tasked with the highly manual process of pulling the reports from the data sources/systems, consolidating/reformatting the data, and implementing diverse business rules to result in a final list of which servers require updates/patches and the schedule for deploying such updates/patches. The manual process is not only inefficient and time-consuming, negatively impacting the critical nature of the deployment process, but also is prone to human error, in which servers requiring updates/patches may be inadvertently overlooked.

Presently, no mechanisms exist that integrate with service management capabilities of information technology infrastructure devices on the enterprise computing network, including development tools, that allow for efficiently and regularly pushing updated software code. Instead, missing servers and other devices may require manual intervention to perform updates or apply patches. Accordingly, service management capabilities have process gaps when identifying security vulnerabilities, unpermitted technology, and/or infiltration incidents which require automatic notification and/or remediation. Because of these process gaps, updated descriptions and/or summaries describing production changes may be unclear to risk and/or audit reviewers so that actual risks cannot be accounted for. Additionally, different domains across the enterprise network may be managed differently and/or independently, so that a consistent vulnerability remediation procedure is not possible. Additionally, when implementing a production update, inconsistent methodologies may result in process violations.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes automatically analyzing code, security updates and patches, intelligently coordinating updates of computing devices throughout the enterprise network and executing change requests.

In some cases, a machine learning (ML) supervisor algorithm may be integrated within a service management computing system to validate the status of release notes and facilitate an automated sign-off of fields with an application owner. The ML supervisor may correlate information with an application identifier (ID), such as an install plan, a backout plan, an application information website (e.g., an intranet website), a pre-approval request and/or response email, an assignee group identifier, and/or a change schedule timing window to update change template. In some cases, the ML supervisor algorithm may connect with a centralized database to pull information directly from the production servers to modify a change template to execute a change request.

In some cases, a security vulnerability portal supervisor algorithm may receive an input (e.g., an entry to a so-called “approaching first consequence” field) as trigger to initiate a change process, using priority information input, an identification number information input, an application owner information input, server detail information input, a vulnerability description information input to match with a data leak, and the like. For updates corresponding to data leak information, according to a description vulnerability change template, the update process is automatically updated to include an install step process, a backout plan, pre-approval request and/or response email(s), an assignee group ID, and/or a change window which collectively leads to execution of a change request.

In some cases, ad hoc requests may be created by a change coordinator for processing emergency update requests, were a requestor provides information inputs to the ML supervisor algorithm, such as an application ID, application group information, server detail information, change window timing information, an assignee group identifier, a description of the change which will further relate with ML Supervisor algorithm to collect required fields from data repository to collaborate with the change template to initiate execution of the change request.

In some cases, a change approval indicator may be provided to an application owner automatically upon generation of a change request has been created to initiate generation of a one-time passcode associated only with that particular change request. The one-time passcode may be sent to one or more members of an assignee group to allow access to perform activities on only those servers which are enrolled in a change window to avoid violation.

Here, a single change template may be used for correction of different vulnerabilities. This may help the enterprise organization coordinate diverse change requests from multiple sources to allow for remediation of various issues. This information technology management system is proactive in nature and coordinates with a base line scanning report that captures the vulnerability identification number and/or identifies servers before it determines any consequences. Use of a data analyzer engine eliminates any dependency from change coordinator interaction and helps automate code deployment to be delivered within a next upcoming change window. A dynamic analyzer engine may be integrated within the system to communicate with a centralized database to ensure impacted servers are identified so that no servers will be missed without any manual interaction being required. To better support change audits, a missing data analysis engine may automatically store and/or replace application installation information pages, create and/or modify an install plan, a backout plan, generate a pre-approval mail to fulfill any auditing documentation requirements. In some cases, an authentication mechanism controller may be used to control authentication changes to ensure server access is securely managed to avoid any policy violations.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for management of information technology infrastructure by coordinating installation of updates and patches, in accordance with one or more aspects described herein;

FIG. 1B shows an illustrative computing platform enabled for management of information technology infrastructure by coordinating installation of updates and patches, in accordance with one or more aspects described herein;

FIG. 2 shows illustrative system for coordinating installation of updates and patches in accordance with one or more aspects described herein; and

FIGS. 3 and 4 show an illustrative data linking process for coordinating installation of updates and patches in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

Automated implementation of code updates and patches is desirable for managing information technology infrastructure of an enterprise computing network. In doing so, updates can be intelligently distributed and deployed, for example, to efficiently utilize scheduled downtimes and coordinate system updates while minimizing network interruptions and/or impact on applications and services provided via the network. Updates and/or patches may come from internal development groups for software-based products and/or services provided by the enterprise organization to internal or external users. Additionally, the updates and/or patches may be provided by one or more different software or firmware vendors to support applications running on networked computing devices and/or firmware or drivers supporting operation of one or more computing devices or portions of computing devices. By using a single common template for differently sourced updates and/or patches, such as to fix identified vulnerabilities, will improve update scheduling activities (e.g., scheduling downtimes, coordinating updates of multiple devices at the same or different geographic locations, and the like) and/or to distribute information about each particular update in a common messaging channel and/or format.

In some cases, the information technology management system may proactively and automatically identify vulnerabilities on for common computing devices based on a vulnerability identifier and/or hardware device identifier before a problem arises. A data analysis engine may process instructions to eliminate one or more dependencies on human intervention and/or manual triggering of code deployment within a scheduled change window. A dynamic data analysis engine may process instructions to integrate one or more connections (e.g., via application programming interface (API) function calls) with a centralized database to identify components (e.g., software frameworks, computing devices, and the like) that integrate components subject to an update, such that impacted software and/or hardware components can be identified and be scheduled for update without manual intervention. In some cases, a template generation engine may process instructions to autonomously analyze updates and patches to automatically update and/or replace application information pages, an install plan, a backout plan, a pre-approval message, one or more audit records, and the like. In some cases, an authentication controller may control authenticated access to servers, based on one or more required updates, based on the automatically generated template, to manage server access to avoid one or more security and/or electronic policy violations.

Therefore, a need exists to automate the process of server remediation in an enterprise-type computing infrastructure, such that the deployment of critical updates/patches across computing servers requiring such deployments is ensured and occurs within prescribed time limits. In this regard, a need exists to automatically extract data from all of the different data sources that contain data relevant to the update/patch process and automatically consolidate and transform/reformat the data to accommodate reporting needs and analytical research. In addition, a need exists to automatically determine the current state of the servers and the OSs, and applications, to determine which servers require a pending update/patch. Moreover, a need exists to automatically determine optimal times for deploying the update/patch to each of the servers requiring such, as scheduling the servers for deployment and implementing the deployment.

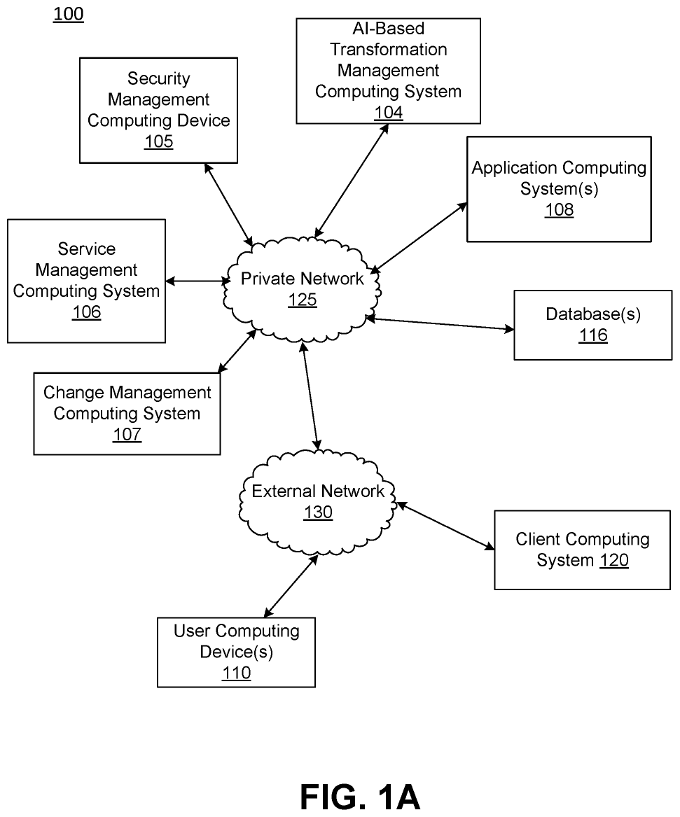

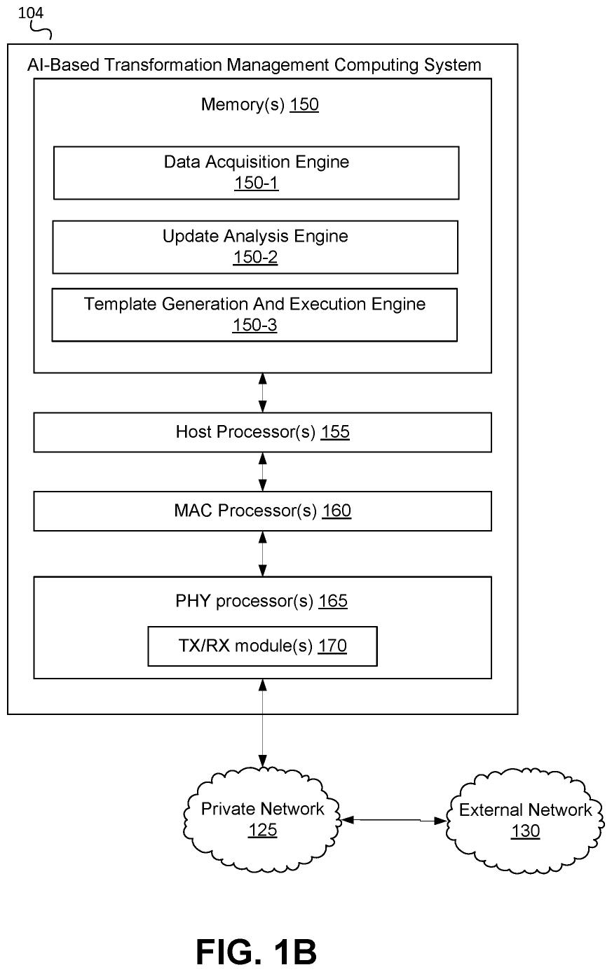

FIG. 1A shows an illustrative computing environment 100 for management of information technology infrastructure by coordinating installation of updates and patches, in accordance with one or more arrangements. The computing environment 100 may comprise one or more devices (e.g., computer systems, communication devices, and the like). The computing environment 100 may comprise, for example, an AI-based transformation management computing system 104, a security management computing system 105, a service management computing system 106, a change management computing system 107, one or more application computing systems 108, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a client computing system 120 and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3r d Generation Partnership Project (3GPP) cellular protocol, a hypertext transfer protocol (HTTP), etc.). While FIG. 1A shows the AI-based transformation management computing system 104, the security management computing system 105, the service management computing system 106, and the change management computing system 107 as separate computing systems, components and/or functionality of each computing system may be incorporated into one or more of the other computing systems.

The AI-based transformation management computing system 104 may comprise one or more computing devices and/or other computer components (e.g., processors, memories, communication interfaces) configured to perform one or more functions as described herein. Further details associated with the architecture of the AI-based transformation management computing system are described with reference to FIG. 1B.

The application computing system 108 and/or an internal client system (not shown) may comprise one or more computing devices and/or other computer components (e.g., processors, memories, communication interfaces). In addition, the application computing systems 108 and/or the internal client system may be configured to host, execute, and/or otherwise provide one or more enterprise applications. In some cases, the application computing systems 108 may host one or more services configured facilitate operations requested through one or more API calls, such as data retrieval and/or initiating processing of specified functionality. In some cases, the internal client computing system may be configured to communicate with one or more of the application systems 108 such as via direct communications and/or API function calls and the services. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The internal client computing system and/or the application computing systems 108 may comprise various servers and/or databases that store and/or otherwise maintain account information, such as financial account information including account balances, transaction history, account owner information, and/or other information. In addition, the internal client computing system and/or the application computing systems 108 may process and/or otherwise execute transactions on specific accounts based on commands and/or other information received from other computer systems comprising the computing environment 100. In some cases, one or more of the internal client computing system and/or the application systems 108 may be configured, for example, to host, execute, and/or otherwise provide one or more transaction processing programs, such as electronic fund transfer applications, online loan processing applications, and/or other programs associated with the financial institution.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125. In some cases, the application computing system 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing system 120 may comprise one or more computing devices and/or other computer components (e.g., processors, memories, communication interfaces). The client computing system 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing system 120 is for processing an electronic exchange of goods and/or services. The client computing system 120 may be associated with a specific goods purchasing activity, such as purchasing a vehicle, transferring title of real estate may perform communicate with one or more other platforms within the client computing system 120. In some cases, the client computing system 120 may integrate API calls to request data, initiate functionality, or otherwise communicate with the one or more application systems 108, such as via the services. For example, the services may be configured to facilitate data communications (e.g., data gathering functions, data writing functions, and the like) between the client computing system 120 and the one or more application systems 108.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125.

The database(s) 116 may comprise one or more computer-readable memories storing information that may be used by the AI-based transformation management computing system 104. For example, the database(s) 116 may store information corresponding to one or more change templates such as service management information, security vulnerability information, adhoc change request information, authorization and/or security information, messaging information, change result information, and the like. In an arrangement, the database(s) 116 may be used for other purposes as described herein. In some cases, the client computing system 120 may write data or read data to the database(s) 116 via the services.

In one or more arrangements, the AI-based transformation management computing system 104, the security management computing system 105, the service management computing system 106, the change management computing system 107, the application computing systems 108, the client computing system 120, the user devices 110, and/or the other devices/systems in the computing environment 100 may be any type of computing device capable of receiving input via a user interface, and communicating the received input to one or more other computing devices in the computing environment 100. For example, the AI-based transformation management computing system 104, the security management computing system 105, the service management computing system 106, the change management computing system 107, the application computing systems 108, the client computing system 120, the user devices 110, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the AI-based transformation management computing system 104, the security management computing system 105, the service management computing system 106, the change management computing system 107, the application computing systems 108, the client computing system 120, the user devices 110, and/or the other devices/systems in the computing environment 100 may, in some instances, be and/or comprise special-purpose computing devices configured to perform specific functions.

FIG. 1B shows an illustrative AI-based transformation management computing system 104 in accordance with one or more examples described herein. The AI-based transformation management computing system 104 may be a stand-alone device and/or may at least be partial integrated one or more other computing systems, such as the security management computing system 105, the service management computing system 106, and the change management computing system 107 and may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The AI-based transformation management computing system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the AI-based transformation management computing system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 155. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the AI-based transformation management computing system 104 may be configured to execute machine readable instructions stored in memory 150. The memory 150 may comprise (i) one or more program modules/engines having instructions that when executed by the one or more processors cause the AI-based transformation management computing system 104 perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the AI-based transformation management computing system 104 and/or by different computing devices that may form and/or otherwise make up the AI-based transformation management computing system 104. For example, the memory 150 may have, store, and/or comprise a data acquisition engine 150-1, a update analysis engine 150-2, a template generation and execution engine 150-3 and/or the like. The data acquisition engine 150-1 may have instructions that direct and/or cause the AI-based transformation management computing system 104 to perform one or more operations associated with monitoring for and/or identifying updates and patches for applications and computerized services running on the enterprise network and gathering information associated with the identified updates and patches, and the like. The update analysis engine 150-2 may have instructions that may cause the AI-based transformation management computing system 104 to perform actions to analyze the identified updates and/or patches, such as to extract information associated with identified updates and patches and intelligently determine an impact of the updates and patches on the network, such as by identifying affected computing devices (e.g., servers, workstations, and the like), downtime schedules, and the like, and to provide output identifying the same. The template generation and execution engine 150-3 may have instructions that may cause the AI-based transformation management computing system 104 to generate a change template based on information stored in a data repository and the information output by the data acquisition engine 150-1 and the update analysis engine 150-2. Additionally, the template generation and execution engine 150-3 may process instructions to execute an update based on the generated template, coordinate approvals and/or status messaging, and the like.

While FIG. 1A illustrates the security management computing system 105, the service management computing system 106, and the change management computing system 107, as being separate elements connected in the private network 125, in one or more other arrangements, functions of one or more of the above may be integrated in a single device/network of devices. For example, elements in the AI-based transformation management computing system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the security management computing system 105, the service management computing system 106, and/or the change management computing system 107.

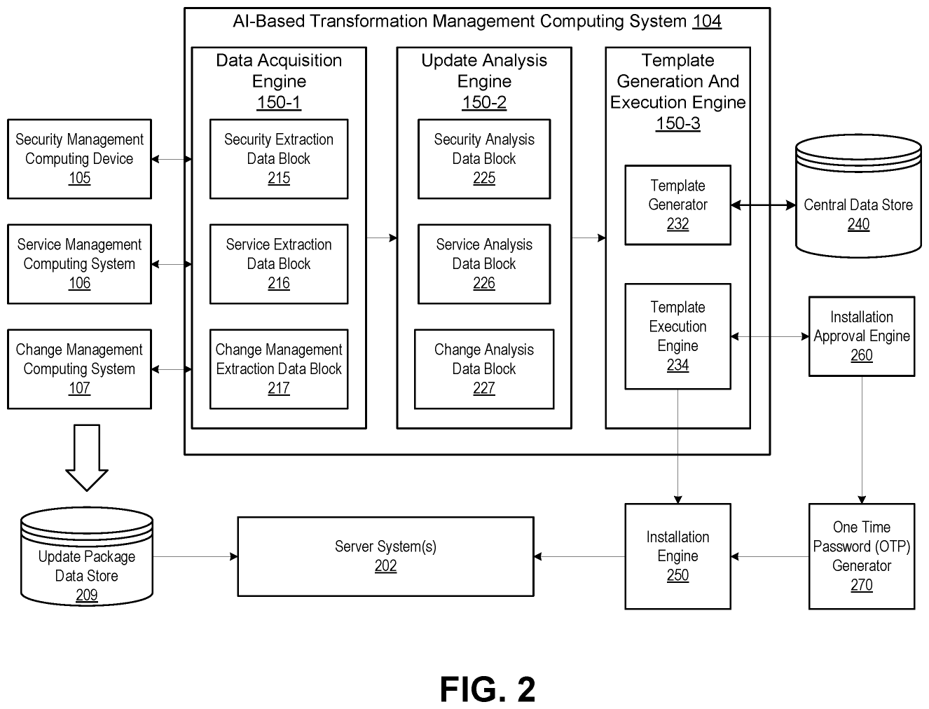

FIG. 2 shows illustrative system for coordinating installation of updates and patches in accordance with one or more aspects described herein. For example, one or more development computing systems and/or vulnerability monitoring and correction computing systems may be used to generate an update or patch for an application or service running on a computing device of the enterprise computing system. For example, the development computing system (e.g., a service management computing system 106) may be used by a software development group to develop software code for compilation into an application or service run by one or more application computing systems 108. The service management computing system 106 may further include one or more computing devices configured for software development, software testing, and/or release management functionality. For example, the computing devices may include a software development computing device running software to allow a software developer to write, compile and test software code. A software test computing device may test builds of software provided by the developers, such as test builds, release builds of applications or portions of applications. In some cases, the software test computing devices may be used to test for or reproduce reported potential software defects identified in the field, such as software defects and/or performance to reproduce anomalies identified in the field. In some cases, the service management computing system 106 may provide a link to a software update install package, information corresponding to the update or patch or a combination of information and software updates. For example, the software management computing system 106 may provide a link to an update install package, a patch install package and/or information such as an application identifier that identifies the software to be updated, an owner of the application and/or the install package (e.g., an application identifier, a service identifier, a firmware identifier, a driver identifier, a hardware identifier, and/or the like), a description of the patch or update (e.g., release notes) of an application, operation system, firmware, software package and/or the like, and one or more indicators (e.g., flags, notes, and the like) such as an indicator of quality assurance acceptance, an indicator that the update or patch is ready for testing (e.g., development testing, unit testing, system testing, installation testing, and the like), an indicator that the patch or update is ready for release and/or the like.

The security management computing device 105 may process instructions to identify and/or install patches or updates to resolve a security vulnerability associated with firmware of a computing device operational on the private network 125 (e.g., the enterprise computing network), an operating system operational on a computing device connected to the enterprise computing network, and/or an application or other software operational on the computing network. For example, a security vulnerability on the network may be identified, such as by the security management computing device and/or other computing devices. A developer or provider of computing hardware (e.g., for firmware updates, driver updates, and the like), a software supplier (e.g., for operating system updates, driver updates, software or application updates and the like), internal development groups (e.g., for updates of internally developed computerized applications or services, and the like) may release patches or updates to fix identified defects and/or security vulnerabilities. In some cases, the security management computing device 105 may provide a link to an update or patch install package, information corresponding to the update or patch or a combination of information and software updates. For example, the security management computing device 105 may provide an application identifier (e.g., an application identifier, a service identifier, a firmware identifier, a driver identifier, a hardware identifier, and/or the like), an identifier of a security vulnerability to be resolved by the patch or update, a description of the vulnerability, a description of the patch or update (e.g., release notes), an owner responsible for the software or firmware to be patched or updated, and/or other information, such as an approaching first, a consequence associated with not installing the patch or update, an indication of a date the vulnerability was first identified, and/or the like.

The change management computing system 107 may process instructions to identify and/or install patches or updates to resolve a request received from system owners and/or users of the computing devices on the enterprise computing network and/or the applications and/or services provided by and/or run on the computing devices of the enterprise computing network. For example, an ad hoc request may indicate a request for an additional feature of a particular application or service, a request to provide support for a previously unsupported feature of a device (e.g., an updated driver), a correction of a defect identified by a user of the application or service, and/or the like. In some cases, the change management computing system 107 may provide a link to an update or patch install package, information corresponding to the update or patch or a combination of information and software updates. For example, the change management computing device 107 may provide an application identifier associated with a particular patch or update, an upgrade identifier to identify whether the install package is an upgrade of features associated with an application or server, a patch identifier to identify whether the install package is a patch to correct a defect associated with the server, a date associated with a build and/or release of the patch, a description of the patch or update (e.g., release notes), an application owner identifier to identify a responsible group or individual that is responsible for support for the computing device, application, service or the like associated with the patch or update.

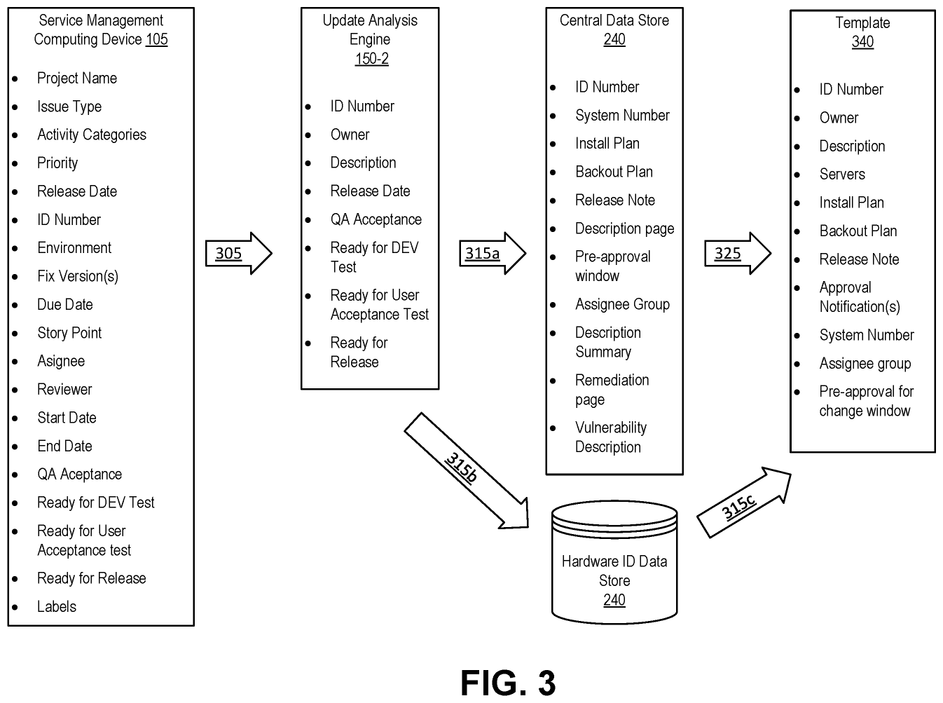

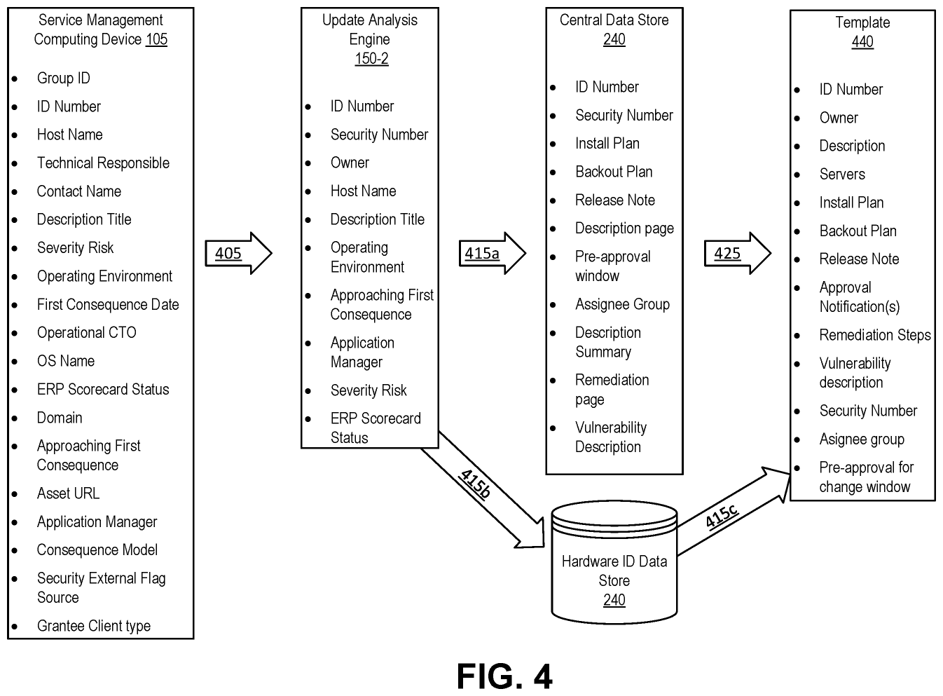

One or more of the components of the AI-Based transformation management computing system 104 may process instructions to perform aspects of an AI/ML supervisor algorithm, such as by the data acquisition engine 150-1, the update analysis engine 150-2, and the template generation and execution engine 150-3. For example, the data acquisition engine 150-1 may be in networked communication with the security management computing system 105, the service management computing system 106, and the change management computing system 107 and may monitor one or more of the devices for an indication that a patch or update is ready for release and/or installation. For example, the data acquisition engine 150-1 may monitor a networked release interface for an indication that a new patch or update is approved for release either periodically or upon receipt of a triggering signal, such as the saving of a release note or other triggering flag (e.g., an approval indicator). In some cases, the data acquisition engine 150-1 may monitor messages regarding a patch or update release corresponding to an application ID, an application owner, a device id, a device type, a service indicator, and/or the like. Once triggered, the data acquisition engine 150-1 may acquire information corresponding to the release such as, for example, as shown in FIGS. 3 and 4.

The data analysis engine 150-2 may analyze information captured or otherwise acquired by the data acquisition engine 150-1. For example, the update analysis engine 150-2 may analyze acquired information (e.g., a security extraction data block 215, a service extraction data block 216, a change management extraction data block, and the like) corresponding to the release or update to one or more of a patch or upgrade to an application. For example, the update analysis engine 150-2 may process one or more acquired data blocks, such as the security extraction data block 215, the service extraction data block 216, and/or the change management extraction data block 217, to output the security analysis data block 225, the service analysis data block 226, and/or the change analysis data block 227.

As part of the analysis, the update analysis engine may intelligently extract information, such as by using a trained predictive model, to identify one or more similar applications that may require coordination of updates and/or to identify each server of a plurality of servers that may require the update or patch to be installed. For example, the enterprise organization may have a multiple servers running different versions of a same operating system, such as in cases where one or more applications running on the server are not yet supported by an updated version. As such, if proper identification of servers is not performed, then the patch or update may cause additional issued, other than those it was meant to resolve. By utilizing the predictive model the update analysis engine may properly identify versions of applications, operating systems, drivers, firmware, and/or the like, that require a particular patch or update. Additionally, the predictive model may also consider servers that cannot support the application. As such, the update analysis engine may provide information to the template generation and execution engine 150-3 that may be used to ensure one or more different servers receive the patch or update and/or exclude one or more servers from receiving the patch or update.

The template generation and execution engine 150-3 may include a template generator 232 and a template execution engine 234. The template generator 232 may receive the extracted and analyzed data sets (e.g., the security analysis data block 225, the service analysis data block 226, and the change analysis data block 227) and may generate a template customized based on the received and analyzed data sets and information retrieved from a centralized data store 240. In some cases, the information retrieved from the centralized data store may include information corresponding to an application, firmware, or operating system subject to the patch or update. Such information may include hardware (e.g., server) information corresponding to an installed location of application, firmware, or operating system subject to the patch or update. For example, the centralized data store 240 may include, for an application, a listing of all servers on which a version is installed. The template generator 232 may receive, as part of the data received from the update analysis engine, an application identifier (e.g., a name, an identification number, and/or the like) and may use the application identifier to retrieve, from the centralized data store 240, information corresponding to the application and/or installation(s) of the application. For instance, the template generator 232 may utilize the information returned from the centralized data store 240 to enrich a generated template, such as by identifying version(s) of the application installed on the system, one or more servers or other computing devices to be updated or patched, additional applications and/or operating systems that may need to be updated based on the patch or update to the application, and/or the like. As such, the template may be used to coordinate updates and patches to an application across one or more devices and/or with other required updates or patches required of other applications, operating systems, drivers, and/or the like.

The template execution engine 234 may initiate processing of the generated template, such as triggering an installation approval engine 260 and/or an installation engine 250. While the installation approval engine 260 and the installation engine 250 are shown as being as being separate, features of the installation engine 250 and the installation approval engine 260 may be incorporated in the other and/or the one or both of the installation engine 250 and the installation approval engine 260 may be incorporated in as a part of the AI-based transformation management computing system 104. The installation approval engine may cause generation, via a visualization generator, of one or more user interface screens detailing a template generated by the template generator 232. For example, user interface screen may include display of affected computing devices to be updated, a computing device that initiated a change resulting in the patch or update to be generated, an informational page detailing problems resolved with the patch or update, features added with the patch or update, applications affected by the update and/or other information that is shown in the illustrative examples of FIGS. 3 and 4. In some cases, the installation approval engine 260 may initiate a request for approval feedback from a responsible user or user group, such as via a internet interface, an email, an instant message and the like. An approval or rejection received may be stored and/or generated in a centralized data store, along with an automated record of the template generation process and/or the installation record of the associated patch or update.

Once an approval input is received, the template execution engine 234 may initiate installation of the patch or update, using the template, by triggering the installation engine 250. In some cases, the approval input may also be used to trigger generation of a one-time password (OTP), via an OTP generator 270, which may include an OTP server configured to generate an OTP for one or more particular devices identified in the template. In some cases, the OTP generator 270 may communicate confirmation of the OTP generation via a messaging interface (e.g., an email interface, an instant messaging interface, a pop-up window interface and/or the like). The installation engine 250 may then perform installation of the patch or update, a copy of which may be accessed or retrieved from an update package data store 209 and installed on the server systems 202. In some cases, the AI-based transformation management computing system 104 may additionally receive feedback about the installation process, such as a success or failure or the installation, an indication that additional devices were missed or were added incorrectly to the installation list in the template, and/or the like. As such, the AI-based transformation management computing system 104 may intelligently and evolve the process and continually train the predictive models used to generate the templates.

FIGS. 3 and 4 show an illustrative data linking process for coordinating installation of updates and patches in accordance with one or more aspects described herein. For example, FIGS. 3 and 4 show how illustrative information associated with different patch or update types can be analyzed and intelligently processed to provide a common release template to facilitate coordinated networked installation of the patch or update. FIG. 3 shows an illustrative automatic mechanism performed by the AI-based transformation management computing system 104 to perform execution of a patch or update resulting from a change request received by a development group. The service management computing device 105 may generate information corresponding to a patch or update resulting from one or more change requests received by a development group internal to the enterprise organization, such as via a defect reporting system. Here, information corresponding to the change request may be updated throughout the development process, where the AI-based transformation management computing system 104 may proactively monitor a data interface to identify when a patch or update is ready for building, installation or otherwise released.

In some cases, the AI-based transformation management computing system 104 may monitor output of the security management computing system 105, the service management computing system 106, and/or the change management computing system 107 for inputs to the predictive model, where the input triggers may include one or more flags used to facilitate and/or trigger prediction of a timing for the release, to plan for coordination of installation with one or more other patches. The AI-based transformation management computing system 104 may begin, based on a particular input, proactively identifying and/or monitoring of target systems to identify an installation time to coordinate installation with other systems, identified times of minimal activity, scheduled downtime and/or the like. In some cases, the target system may be identified by one or more of an application identifier, a project name, an issue type, and/or a flag (e.g., a development test flag, an acceptance test flag, a release flag, and/or the like). For example, the development test flag may trigger the model to generate a template for installation on one or more testing computing systems and the release flag may trigger the model to generate a template for installation on one or more production or application computing systems, and the like.

In FIG. 3, the monitoring may be performed as a series of queries generated by the AI-based transformation management computing system 104 via one or more application programming interface (API) functions at 305. The API calls may be implemented by the AI-based transformation management computing system 104 to pull data from the security management computing system 105, the service management computing system 106, and/or the change management computing system 107 and/or the API functions may be implemented on the security management computing system 105, the service management computing system 106, and/or the change management computing system 107 to push information to the AI-based transformation management computing system 104 or a combination of functionality. In some cases, a flag input (e.g., a ready for release flag) may be used as a first confirmation that a particular template is to be generated. At 315b, the AI-based transformation management computing system 104 may analyze benchmarks stored in the data store 240 and/or other data stores, and may synthesize information stored in the centralized data store 240 to modify the received data to customize the template for a particular installation.

At 315b, the predictive model of the AI-based transformation management computing system 104 may query production servers based on the information received from the security management computing system 105, the service management computing system 106, and/or the change management computing system 107 and/or may request information from one or more associated users identified from the received data to customize a template base on the information received from the security management computing system 105, the service management computing system 106, and/or the change management computing system 107. At 315c, information customized in the data store 240 may be used to customize the template, such as including the identified owner of the update or patch (e.g., a user responsible for approving a release) and/or a listing of computing devices (e.g., servers) on which the update is to be installed and the installation is coordinated with downtime or other times of minimal activity at the affected servers. At 325, the predictive model of the AI-based transformation management computing system 104 may formulate the template based on the inputs and predictive installation targets and the AI-based transformation management computing system 104 may then generate the template. In FIG. 4, steps 405, 415a-c, and 425 perform similar activities, based on different data from a different data source, as steps 305, 315a-c, and 325 discussed above.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method comprising:
monitoring, by a transformation management computing system, data output by a plurality of computing systems, the data output comprising an identification of an install package;
triggering, based on an installation indicator, identification of one or more computing devices running an application corresponding to the install package;
identifying, by a trained artificial intelligence model based on the data output, additional information corresponding to the install package;
generating, by the trained artificial intelligence model, an installation template customized for the install package; and
automatically, by the transformation management computing system, triggering installation of the install package on the one or more computing devices.

2. The method of claim 1, wherein the plurality of computing systems comprises at least one or more of a security management computing system, a service management computing system, and a change management computing system.

3. The method of claim 1, wherein the data output by the plurality of computing systems comprises a flag indicative of a build of an installation package.

4. The method of claim 3, wherein the flag corresponds to at least one of an indication of an application ready for test or an application ready for release.

5. The method of claim 1, wherein monitoring data output by a plurality of computing systems, the data output comprising an identification of an install package comprises pushing, by one or more of the plurality of computing systems, the data output via an application programming interface call.

6. The method of claim 1, wherein monitoring data output by a plurality of computing systems, the data output comprising an identification of an install package comprises pulling, by the transformation management computing system, the data output via an application programming interface call.

7. The method of claim 1, comprising:
sending, by the transformation management computing system, a request for approval of the installation;
triggering, based on a received approval input, generation of a one-time password from a password server; and
wherein triggering installation of the install package on the one or more computing devices is triggered by receipt of the one-time password.

8. A computing platform comprising:
a processor;
a network interface communicatively coupled to the processor; and
non-transitory memory storing instructions that, when executed by the processor, cause the processor to:
monitor data output by a plurality of computing systems, the data output comprising an identification of an install package;
trigger, based on an installation indicator, identification of one or more computing devices running an application corresponding to the install package;
identify, by a trained artificial intelligence model based on the data output, additional information corresponding to the install package;
generate, by the trained artificial intelligence model, an installation template customized for the install package; and
trigger automatic installation of the install package on the one or more computing devices.

9. The computing platform of claim 8, wherein the plurality of computing systems comprises at least one or more of a security management computing system, a service management computing system, and a change management computing system.

10. The computing platform of claim 8, wherein the data output by the plurality of computing systems comprises a flag indicative of a build of an installation package.

11. The computing platform of claim 10, wherein the flag corresponds to at least one of an indication of an application ready for test or an application ready for release.

12. The computing platform of claim 8, wherein the instructions to monitor data output by a plurality of computing systems, the data output comprising an identification of an install package comprises an instructions that cause the computing device to receive, from one or more of the plurality of computing systems, the data output via an application programming interface call.

13. The computing platform of claim 8, wherein the instructions to monitor data output by a plurality of computing systems, the data output comprising an identification of an install package comprises an instructions that cause the computing device to pull the data output via an application programming interface call.

15. The computing platform of claim 8, wherein the instructions further cause the computing platform to:
send, by the transformation management computing system, a request for approval of the installation;
trigger, based on a received approval input, generation of a one-time password from a password server; and
wherein installation of the install package on the one or more computing devices is triggered by receipt of the one-time password.

16. Non-transitory memory storing instructions that, when executed by the processor, cause the processor to:
monitor data output by a plurality of computing systems, the data output comprising an identification of an install package;
trigger, based on an installation indicator, identification of one or more computing devices running an application corresponding to the install package;
identify, by a trained artificial intelligence model based on the data output, additional information corresponding to the install package;
generate, by the trained artificial intelligence model, an installation template customized for the install package; and
trigger automatic installation of the install package on the one or more computing devices.

17. The non-transitory memory of claim 16, wherein the plurality of computing systems comprises at least one or more of a security management computing system, a service management computing system, and a change management computing system.

18. The non-transitory memory of claim 16, wherein the data output by the plurality of computing systems comprises a flag indicative of a build of an installation package.

19. The non-transitory memory of claim 16, wherein the instructions to monitor data output by a plurality of computing systems, the data output comprising an identification of an install package comprises an instructions that cause the computing device to receive, from one or more of the plurality of computing systems, the data output via an application programming interface call.

20. The non-transitory memory of claim 16, wherein the instructions further cause the computing platform to:
send, by the transformation management computing system, a request for approval of the installation;
trigger, based on a received approval input, generation of a one-time password from a password server; and
wherein installation of the install package on the one or more computing devices is triggered by receipt of the one-time password.
